(19) United States
(12) Patent Application Publication
(10) Pub. No.: US 2022/0010141 A1
(43) Pub. Date: Jan. 13, 2022

(54) METHOD FOR COATING A PISTON

(71) Applicant: Mahle International GmbH, Stuttgart (DE)

(72) Inventors: Stephan Koerner, Loechgau (DE); Alois Lecker, Stuttgart (DE); Daniel Lopez, Stuttgart (DE); Reinhard Rose, Fellbach (DE)

(21) Appl. No.: 17/368,800

(22) Filed: Jul. 6, 2021

(30) Foreign Application Priority Data
Jul. 7, 2020 (DE) 102020208462.9

(51) Int. Cl. C09D 1/02; F02F 3/14; C09D 7/40; C09D 7/61; C09D 7/20

(52) U.S. Cl. CPC C09D 1/02; F02F 3/14; C09D 7/20; C09D 7/61; C09D 7/70; C09D 7/69

(57) ABSTRACT

A method for coating a piston of an internal combustion engine may include providing the piston, which may include a piston skirt and a piston crown with a fire land. The method may also include producing a ceramic suspension, which may include a solvent, a binder dissolved in the solvent, a plurality of hollow glass spheres distributed in the binder, and a plurality of ceramic particles distributed in the binder. The method may further include applying the ceramic suspension onto the piston and producing a coating on the piston via removing the solvent from the applied ceramic suspension. The coating may have a matrix formed by the binder in which the plurality of hollow glass spheres and the plurality of ceramic particles are arranged in a distributed manner.

The present invention relates to a method for coating a piston of an internal combustion engine. The invention relates, in addition, to a piston coated in such a manner.

Pistons come into use in internal combustion engines and are arranged adjustably in a cylinder of the internal combustion engine. A piston crown of the piston, which usually has a fire land, delimits, with the cylinder, a combustion chamber, in which, in operation of the internal combustion engine, a fuel mixture burns. The piston, in particular the piston crown, and the cylinder are therefore exposed to high thermal and thermochemical loads.

To increase the efficiency of the internal combustion engine and/or to improve the so-called knocking behaviour, a controlled and sufficient combustion of the fuel is necessary. This requires in particular a desired temperature distribution or respectively a desired minimum temperature within the entire combustion chamber. The piston constitutes, with its components delimiting the combustion chamber, i.e. in particular with the piston crown, an edge of the combustion chamber, which can potentially have a reduced temperature compared to the adjoining combustion chamber. This leads to deposits, in particular of soot, and/or to an undesirably reduced combustion of the fuel. This effect is intensified in that pistons generally have a cooling duct arranged in the vicinity of the piston crown, via which the piston, and in particular the piston crown, is cooled during operation.

From DE 31 33 223 C2 it is known to coat a piston, in particular the piston crown, with a coating which, through a predetermined thermal penetration ability and through a predetermined thermal conductivity, reduces an intensive cooling of the region of the piston delimiting the combustion chamber. The coating comprises hollow spheres and inorganic substances, which are received in a polyamide hard foam.

From DE 10 2012 025 283 A1 it is known to use, as coating of a piston, a closed-pore foam.

In DE 10 2017 207 236 A1 a piston is disclosed, which is coated with a ceramic composite thermal barrier coating based on zirconium dioxide.

A disadvantage in the coatings of pistons known from the prior art is, in particular, an insufficient and/or irregular barrier or respectively reduction of the heat input from the combustion chamber to the piston. This leads, in operation, to increased deposit on the piston and/or to a reduced efficiency of the associated internal combustion engine.

The present invention is therefore concerned with the object of indicating, for a method for coating a piston with a coating and for such a piston, improved or at least different embodiments, which are distinguished by reduced deposits on the piston in operation, and/or an increased efficiency of the associated internal combustion engine.

This problem is solved according to the invention by the subjects of the independent claims. Advantageous embodiments are the subject of the dependent claims.

The present invention is based on the general idea of coating a piston through the application of a ceramic suspension, wherein ceramic particles and hollow glass spheres are arranged in the suspension in a distributed manner. This permits a uniform distribution of the ceramic particles and of the hollow glass spheres in the suspension and thus in the coating which is produced by the applying of the suspension. A uniform formation of the coating with regard to the thermal characteristics, in particular with regard to the reduction of the thermal penetration depth and/or a thermal barrier, achieved with the coating, thus result over the entire coating. Furthermore, in this way, the ceramic particles and the hollow glass spheres can be applied in this way on the piston in a simplified manner with a desired distribution and/or a desired size, in particular size distribution, wherein the size distribution and the form of the hollow glass spheres and of the ceramic particles are retained in the subsequently produced coating. The idea according to the invention therefore allows a coating to be produced in which hollow glass spheres and ceramic particles are uniformly distributed and in which the form and/or size of the ceramic particles and of the hollow glass spheres can be selected reliably and in a targeted manner. Consequently, by the coating, an improved reduction of the thermal penetration depth is achieved between the piston and a combustion chamber delimited by the piston in an associated cylinder of an internal combustion engine. At the same time, through the reduced thermal penetration depth into the piston, the coating leads to a reduction of the thermally caused loads and damage to the piston. Consequently, deposits on the piston are reduced and the combustion of a fuel in the combustion chamber is improved, so that the efficiency of the internal combustion engine is improved with an increased lifespan of the piston.

In accordance with the idea of the invention, the piston is provided for coating the piston with the coating. The piston has a piston skirt and a piston crown. With use in an associated cylinder of an internal combustion engine, together with the cylinder, the piston crown delimits the combustion chamber. For coating the piston, firstly the ceramic suspension is produced. The ceramic suspension comprises a solvent and a binder, which is dissolved in the solvent. The hollow glass spheres and the ceramic particles are distributed in the binder. The suspension is applied on the piston for coating the piston. The dissolving of the solvent takes place for the producing of the coating, so that the binder forms a matrix of the coating, in which the hollow glass spheres and the ceramic particles are arranged in a distributed manner.

The dissolving of the solvent can take place basically in any desired manner. In particular, the dissolving of the solvent can be achieved by a vaporizing and/or burning of the solvent.

The piston crown advantageously has a fire land. Thus, in operation of the piston, an improved combustion takes place in the combustion chamber.

In addition to the solvent, the binder, the hollow glass spheres and the ceramic particles, the suspension can contain components for the stabilizing of the suspension. These include in particular dispersing aids and stabilizers such as, for example, surfactants and silicanes.

The production of the coating, in particular the dissolving of the solvent, takes place expediently in such a manner that a destruction of the hollow glass spheres does not occur.

The coating can basically have any desired thickness.

It is preferred if the coating has a layer thickness between 150 μm and 200 μm. A sufficiently high mechanical and/or thermochemical stability of the coating with, at the same time, sufficiently low thermal penetration depth into the piston, is thus achieved.

The coating is expediently impermeable to gases, in particular to oxygen, and to fluids, in particular to water. In this way, thermochemical loads of the piston are reduced. In addition, damage to the coating, which can be caused by the penetrating of gases and/or liquids into the coating, are prevented or at least reduced.

The coating can basically be coated on any desired region of the piston.

Preferably, the coating is coated at least on the piston crown, advantageously together with the fire land. As the piston crown together with the fire land in the associated cylinder delimits the combustion chamber, a particularly effective protection of the piston and/or an advantageous reduction of deposits and increase of the burnt fuel is thus achieved. It is further preferred if the coating is applied exclusively on the piston crown. The piston can thus be produced at a more favourable cost.

It is advantageous if the coating forms the outermost layer of the piston, in particular of the piston crown. The heat transmission from the combustion chamber into the piston and/or other layers which can be arranged between the piston and the coating, is thus reduced, so that an improved protection of the piston, together with other possibly present layers, takes place.

In preferred embodiments, the piston is coated in such a manner that the coating contains a proportion of at least 50 mass percent, also designated below as %-mass, of the ceramic particles. This means in particular that the ceramic suspension contains a corresponding proportion of ceramic particles. Embodiments are deemed as being particularly preferred in which the coating contains a proportion of between 50%-mass and 80%-mass ceramic particles, particularly preferably 69%-mass ceramic particles.

Basically, the binder can be any desired binder, in so far as the latter is suitable for the production of the coating, and is resistant, in particular temperature-resistant, with respect to the operation in the associated internal combustion engine.

Embodiments are preferred in which the binder is an inorganic binder, particularly preferably an ionically inorganic binder. This means that the ceramic suspension is produced with an inorganic binder, in particular an ionic inorganic binder. Accordingly, the matrix of the coating concerns an inorganic matrix preferably an ionic inorganic matrix.

The, in particular ionic, inorganic binder is preferably a salt, in particular a phosphate, for example monoaluminium phosphate and/or polyphosphate. This means that the ceramic suspension is produced with a salt, in particular with a phosphate, for example monoaluminium sulphate and/or polyphosphate, as binder.

Alternatively or additionally, the binder can be water glass or respectively can contain water glass. This means that the ceramic suspension is produced alternatively or additionally with water glass as binder. The water glass concerns here in particular amorphous sodium silicate and/or potassium silicate.

It is likewise conceivable to use as binder, alternatively or additionally, bentonite, kaolinite, montmorillonite, cement, gypsum, unburnt lime and suchlike.

The solvent can basically be any one that is desired, in so far as it permits the dissolving of the binder in the suspension. In particular, the solvent can have several components.

It is preferred if the solvent is aqueous. This means that the suspension is produced with an aqueous solvent.

Alternatively or additionally, the solvent can be a polar solvent for the dissolving of salts, in particular of the ionically inorganic binder. This means that the suspension is alternatively or additionally produced with a polar solvent for the dissolving of salts.

It is conceivable that the solvent alternatively or additionally contains short-chain alcohols. This means that the suspension is produced alternatively or additionally with short-chain alcohols as solvent.

Preferably and expediently, the matrix, and thus the binder, makes up a small proportion of the produced coating.

Preferably, the matrix makes up as a maximum 5%-mass of the produced coating. Particularly preferably, the matrix makes up 3%-mass of the produced coating. This means that the piston is coated in such a way that the produced coating has a proportion of less than 5%-mass, preferably 3%-mass, the coating therefore consists as a maximum 5%-mass of the matrix or respectively the binder.

The ceramic particles can basically be any desired particles.

The ceramic particles preferably concern oxides, nitrides, carbides or mixtures thereof. In particular, the ceramic particles concern zirconium dioxide, sapphire (Al₂O₃), titanium dioxide, silicon dioxide and suchlike or mixtures thereof.

Embodiments are deemed to be advantageous in which the ceramic particles in the matrix and therefore in the coating have a size distribution with d50 between 0.5 μm and 1 μm, in particular 0.8 μm. d50 indicates in particular that 50% of the particles are smaller than the indicated value and/or 50% greater than the indicated value.

The hollow glass spheres of the suspension and therefore of the coating can basically be produced from any desired material or substance.

Embodiments are deemed to be preferred in which the hollow glass spheres are produced from a metal oxide or metal oxides. Preferably, the hollow glass spheres are produced from silicon dioxide. For example, the hollow glass spheres can be glass bubbles of the “S32HS” type of the provider 3M. Alternatively or additionally, hollow glass spheres can come into use which consist of silicon dioxide.

It is conceivable to use, alternatively or additionally, borosilicate glasses as hollow glass spheres.

The hollow glass spheres in the coating preferably have a size distribution with d50 between 20 μm and 65 μm. This means that the piston is coated in such a manner that the hollow glass spheres in the coating have a size distribution with d50 between 20 μm and 65 μm.

Advantageously, the coating has a mass fraction of the hollow glass spheres which lies below the proportion of the ceramic particles and above the proportion of the matrix.

Embodiments are deemed to be preferred in which the proportion of the hollow glass spheres in the coating lies between 25%-mass and 35%-mass, preferably 28%-mass. This means that the piston is coated in such a manner that the coating has a proportion of between 25%-mass and 35%-mass, in particular 28%-mass, hollow glass spheres.

It shall be understood that in addition to the method for coating the piston which is coated with the coating belongs as such to the scope of this invention.

Further important features and advantages of the invention will emerge from the subclaims, from the drawing and from the associated FIGURE description with the aid of the drawing.

It shall be understood that the features mentioned above and to be explained further below are able to be used not only in the respectively indicated combination, but also in other combinations or in isolation, without departing from the present invention.

A preferred example embodiment of the invention is illustrated in the drawing and is explained more closely in the following description, wherein the same reference numbers refer to identical or similar or functionally identical components.

There is shown in the single

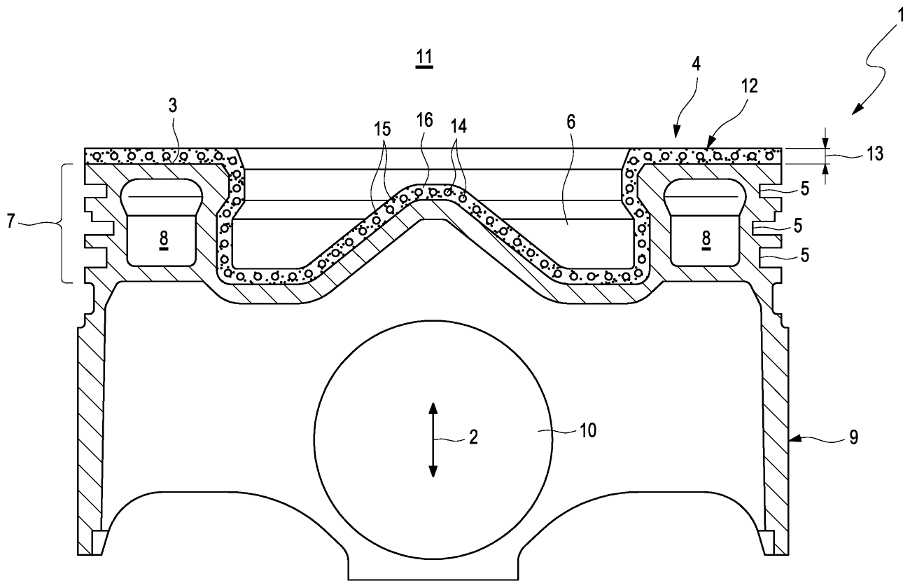

FIG. 1 a section through a piston.

A piston 1, as is shown for example in FIG. 1, has in an axial direction 2 externally a face side 3. On the face side 3 of the piston 1, the piston 1 has a piston crown 4, which extends axially into the piston 1 and has a fire land 6. The piston 1 of the example embodiment which is shown has radially externally at least one annular groove 5. In the example embodiment which is shown, three such annular grooves 5 are provided, purely by way of example. The annular grooves 5 extend respectively circumferentially and are open radially outwards. In at least one of the annular grooves 5, advantageously in the respective annular groove 5, a piston ring is received, which is not shown. The annular grooves 5 are arranged here in a ring belt 7 of the piston 1. A cooling duct 8 of the piston 1, which runs circumferentially, can be arranged radially between the annular grooves 5 and the piston crown 4, in particular the fire land 6. The cooling duct 8 serves for cooling the piston 1 and can be filled with a corresponding coolant and/or supplied therewith in operation.

On the side of the ring belt 7 facing away axially from the face side 3, the piston 1 has a piston skirt 9, also designated as piston body 9. The piston 1 has, furthermore, a bolt hole 10, which is spaced apart axially with respect to the face side 3. The piston 1 is connected via the bolt hole 10 with an associated connecting rod, not shown, of an associated internal combustion engine, which is otherwise not shown. In the associated internal combustion engine, the piston crown 4, with a cylinder which is not shown, delimits a combustion chamber 11.

The piston 1 is coated with a coating 12, which in the example embodiment which is shown is coated on the piston crown 4 together with fire land 6. The coating 12 has a coating thickness 13 between 150 μm and 200 μm and is illustrated in an enlarged manner in FIG. 1 for better understanding. The coating 12 contains hollow glass spheres 14, indicated in a circular shape, and ceramic particles 15, indicated in a punctiform manner, which are uniformly distributed in the coating 12. The hollow glass spheres 14 and the ceramic particles 15 are received in a matrix 16 of the coating 12.

The coating 12 consists between 50 mass percent, also designated below as %-mass, and 80%-mass, in particular 69%-mass, of the ceramic particles 15. Here, the ceramic particles 15 have a size distribution with d50 between 0.5 μm and 1 μm, in particular 0.8 μm. The ceramic particles 15 concern in particular oxides, nitrides, carbides or mixtures thereof. In particular, the ceramic particles 15 concern zirconium dioxide, sapphire, titanium dioxide, silicon dioxide and suchlike.

The coating 12 consists maximally 5%-mass of the matrix 16. In particular, the coating 12 consists maximally 3%-mass of the matrix 16.

The hollow glass spheres 14 are preferably produced from metal oxides, consist in particular of metal oxides. The hollow glass spheres 14 are advantageously produced from silicon dioxides, consist in particular of silicon dioxide. Here, the coating 12 preferably consists between 25%-mass and 35%-mass, advantageously 28%-mass, of the hollow glass spheres 14. The hollow glass spheres 14 have a size distribution with d50 between 20 μm and 65 μm.

The coating 12 is expediently impermeable to water and vapour and air, in particular oxygen.

For coating the piston 1 with the coating 12, a suspension of a solvent and of a binder is produced, wherein the binder forms the matrix 16 in the subsequent coating 12. The hollow glass spheres 14 and the ceramic particles 15 are distributed in the binder. The suspension is applied on the piston 1, in particular on the piston crown 4, and the solvent is subsequently dissolved, for example evaporated and/or burnt.

The solvent preferably concerns an aqueous solvent, which alternatively or additionally can be polar. Likewise, it is conceivable that the solvent contains short-chain alcohols.

The binder preferably concerns an inorganic, preferably ionic, binder. In particular, the binder is a salt, for example phosphate, in particular monoaluminium phosphate and/or polyphosphate. Alternatively or additionally, the binder can contain water glass.

The coating 12 reduces the heat transmission from the combustion chamber 11 to the piston crown 4. Consequently, the coating 12 delimiting the combustion chamber 11 has a uniform temperature and which is increased compared to the piston crown 4. This leads to an improved combustion behaviour of the fuel which is burnt in the combustion chamber 11, and to a reduced load of the piston 1, in particular of the piston crown 4.

1. A method for coating a piston of an internal combustion engine, comprising:
providing the piston, which includes a piston skirt and a piston crown with a fire land;
producing a ceramic suspension including:
a solvent
a binder dissolved in the solvent;
a plurality of hollow glass spheres distributed in the binder; and
a plurality of ceramic particles distributed in the binder;
applying the ceramic suspension onto the piston; and
producing a coating on the piston via removing the solvent from the applied ceramic suspension, the coating having a matrix formed by the binder in which the plurality of hollow glass spheres and the plurality of ceramic particles are arranged in a distributed manner.

2. The method according to claim 1, wherein the coating has a proportion of at least 50%-mass formed by the plurality of ceramic particles.

3. The method according to claim 1, wherein the binder is an inorganic binder.

4. The method according to claim 3, wherein the binder includes at least one of:
a salt; and
water glass.

5. The method according to claim 1, wherein the solvent is at least one of:
an aqueous solvent;
a polar solvent for dissolving salts; and
a short-chain alcohol solvent.

6. The method according to claim 1, wherein the coating has a proportion of less than 5%-mass formed by the matrix.

7. The method according to claim 1, wherein the plurality of ceramic particles includes at least one of oxides, nitrides, and carbides.

8. The method according to claim 1, the plurality of ceramic particles in the coating have a size distribution with a d50 of 0.5 μm to 1.0 μm.

9. The method according to claim 1, wherein the plurality of hollow glass spheres are composed of silicon dioxide.

10. The method according to claim 1, wherein the plurality of hollow glass spheres in the coating have a size distribution with a d50 of 20 μm to 65 μm.

11. The method according to claim 1, wherein the coating has a proportion of 25%-mass to 35%-mass formed by the plurality of hollow glass spheres.

12. A piston of an internal combustion engine, comprising a piston skirt, a piston crown, and a coating, wherein the coating is provided in accordance with the method according to claim 1.

13. The method according to claim 1, wherein:
applying the suspension onto the piston includes applying the suspension onto the piston crown and the fire land; and
producing the coating on the piston includes producing the coating on the piston crown and the fire land.

14. The method according to claim 1, wherein the coating has a layer thickness of 50 μm to 100 μm.

15. The method according to claim 1, wherein removing the solvent is performed in a manner that does not destroy the plurality of hollow glass spheres.

16. The method according to claim 1, wherein the binder includes monoaluminium phosphate.

17. The method according to claim 1, wherein a first mass fraction of the coating formed by the plurality of hollow glass spheres is (i) less than a second mass fraction of the coating formed by the plurality of ceramic particles and (ii) greater than a third mass fraction of the coating formed by the matrix.

18. The method according to claim 1, wherein:
the plurality of ceramic particles form 69%-mass of the coating;
the matrix forms less than 3%-mass of the coating; and
the plurality of hollow glass spheres form 28%-mass of the coating

19. A method for coating a piston of an internal combustion engine, comprising:
providing the piston, which includes a piston skirt and a piston crown with a fire land;
producing a ceramic suspension including:
a polar solvent;
an ionic inorganic binder dissolved in the solvent;
a plurality of hollow glass spheres distributed in the binder; and
a plurality of ceramic particles distributed in the binder, the plurality of ceramic particles including at least one of oxides, nitrides, and carbides;
applying the ceramic suspension onto the piston; and
producing a coating on the piston via removing the solvent from the applied ceramic suspension, the coating having a matrix formed by the binder in which the plurality of hollow glass spheres and the plurality of ceramic particles are arranged in a distributed manner.

20. A method for coating a piston of an internal combustion engine, comprising:
providing the piston, which includes a piston skirt and a piston crown with a fire land;
producing a ceramic suspension including:
a solvent;
a binder dissolved in the solvent;
a plurality of hollow glass spheres distributed in the binder; and
a plurality of ceramic particles distributed in the binder;
applying the ceramic suspension onto the piston;
producing a coating on the piston via removing the solvent from the applied ceramic suspension, the coating having a matrix formed by the binder in which the plurality of hollow glass spheres and the plurality of ceramic particles are arranged in a distributed manner;
wherein the plurality of ceramic particles form at least 50%-mass of the coating;
wherein the matrix forms less than 5%-mass of the coating; and
wherein the plurality of hollow glass spheres form 25 to 35%-mass of the coating.
